(19) United States
(12) Patent Application Publication
(10) Pub. No.: US 2008/0152336 A1
(43) Pub. Date: Jun. 26, 2008

(54) Imaging apparatus and method of controlling imaging

(75) Inventors: Toshita Hara, Tokyo (JP); Yoshikuni Nishiura, Tokyo (JP); Yuuki Okabe, Tokyo (JP); Akemi Oda, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, TOKYO (JP)

(21) Appl. No.: 12/003,169

(22) Filed: Dec. 20, 2007

(30) Foreign Application Priority Data
Dec. 26, 2006 (JP) 2006-350373

(51) Int. Cl. G03B 17/24

(52) U.S. Cl. 396/311

(57) ABSTRACT

An imaging apparatus comprises: a shooting requesting unit which receives an input indicating that shooting request to a person is made; and a shooting request mode setting unit which sets an angle of view of the image data displayed by the display unit to a predetermined range smaller than an angle of view captured by the imaging unit in response to the input to the shooting requesting unit. The display unit displays a post-view image which is an image data decoded from compressed coded image data in the recording unit within a range of the displayed angle of view set by the shooting request mode setting unit. Thus, the image actually recorded and displayed in the reproducing mode includes larger region of the post-view image. Therefore, the cutoff of heads and legs, etc. of an object at a peripheral region of the image can be compensated.

### BACKGROUND OF THE INVENTION

1. Field of the Invention

The present invention relates to the control of operation of a camera in response to a request for shooting a photograph made by a camera user to others.

2. Description of the Related Art

According to Japanese Patent Application Laid-Open No. 2006-211489, images different in angle of view can be picked up in incremental steps and recorded by a digital zoom. According to Japanese Patent Application Laid-Open No. 07-288802, if an object intrudes into a supervised area, the object is cut out into a rectangular frame and the frame is enlarged and displayed by a digital zoom and stored.

When a commemorative picture including a camera owner is taken, and the owner cannot well instruct others to take the picture, which often results in a defective photo which blurs in focus, shakes, is ill-composed and too small in an object.

### SUMMARY OF THE INVENTION

The present invention has been made in view of the above problems and for its purpose to provide a camera whereby a person who is asked to shoot a photograph can take it which satisfies a person who asks him or her to do it without shooting again.

According to an aspect of the present invention, in an imaging apparatus including an imaging unit which receives light incident from an object through an imaging lens, continuously converts it into an image signal and outputs the image signal, an image data conversion unit which converts the image signal output from the imaging unit into an image data and outputs the image data, a recording instruction unit which receives a recording instruction of the image data, an exposure controlling unit which controls the exposure of the imaging unit in response to the recording instruction unit receiving the recording instruction, a recording unit which records the image data converted from the image signal output from the imaging unit in response to control of exposure by the exposure controlling unit and a display unit which displays the image data recorded at least in the recording unit, the imaging apparatus comprises: a shooting requesting unit which receives an input indicating that shooting request to a person is made; and a shooting request mode setting unit which sets an angle of view of the image data displayed by the display unit to a predetermined range smaller than an angle of view captured by the imaging unit in response to the input indicating that shooting request to a person is made inputted to the shooting requesting unit; wherein the display unit displays a post-view image which is an image data decoded from compressed coded image data in the recording unit within a range of the displayed angle of view set by the shooting request mode setting unit.

According to the aspect of the present invention, even if the composition looks bad in the post-view image, the image actually recorded and displayed in the reproducing mode includes a peripheral region outside of the post-view image. The cutoff of heads and legs, etc. of an object at the upper and the lower part of the image can be compensated, so that there is no need for shooting again.

According to a further aspect of the present invention, the shooting request mode setting unit may be preferable to perform, in response to the input that shooting request to a person is made inputted to the shooting requesting unit, at least one of the following: setting the number of pixels in which image data is recorded to the maximum number of pixels; setting the high sensitivity mode; setting an automatic exposure adjustment mode and an automatic focus adjustment mode according to face recognition; releasing the automatic power-off of the backlight in the display unit; releasing the automatic power-off of the imaging apparatus main body; setting a quick shot mode; setting a continuous shooting mode; stopping the display of an icon in a live-view image or limitation thereof; and nullifying the operation of other buttons except a shutter button until the shutter button is completely depressed.

According to a further aspect of the present invention, the display unit may be preferable to continuously display the post-view image until a reproducing mode for the image data is set after the recoding unit has compressed and coded the image data and recorded it.

According to a further aspect of the present invention, the recoding unit may be preferable to associate information identifying the displayed angle of view set by the shooting request mode setting unit with the image data and record the information.

According to a further aspect of the present invention, a method of controlling shooting includes the steps of: receiving an input indicating that shooting request to a person is made; setting a displayed angle of view of an image data to a predetermined range smaller than a shooting angle of view in response to the input indicating that shooting request to a person is made; and displaying a shot image data within the range of the set displayed angle of view.

According to the aspect of the present invention, even if the composition looks bad in the post-view image, the image actually recorded and displayed in the reproducing mode includes a peripheral region outside of the post-view image. The cutoff of heads and legs, etc. of an object at the upper and the lower part of the image can be compensated, so that there is no need for shooting again.

### BRIEF DESCRIPTION OF THE DRAWINGS

FIG. 1 is a block diagram of a camera;

FIG. 2 is a picture illustrating that a camera user is looking for someone who seems to take its group photo;

FIG. 3 is a picture illustrating that the camera user asks someone to take its group photo;

FIG. 4 is a picture illustrating that a “Request shot mode” is set;

FIG. 5 is a picture illustrating that a shooter determines composition while referring to a live-view image and depresses a release switch;

FIG. 6 is a picture illustrating that the shooter bring the camera back to the user with the post-view image displayed;

FIG. 7 is a picture illustrating that the camera user ascertains a captured image through the post-view display;

FIG. 8 is a picture illustrating that the camera user ascertains the captured image through the post-view display;

FIG. 9 is a picture illustrating that the whole captured image is displayed in the reproducing mode;

FIG. 10 is a picture illustrating that the camera user and group members ascertain that a satisfactory image is captured; and

FIG. 11 is a picture illustrating one example of the display range of the post-view image and an actual recording range.

### DETAILED DESCRIPTION OF THE PREFERRED EMBODIMENTS

A preferable embodiment is described below with reference to the appended drawings.

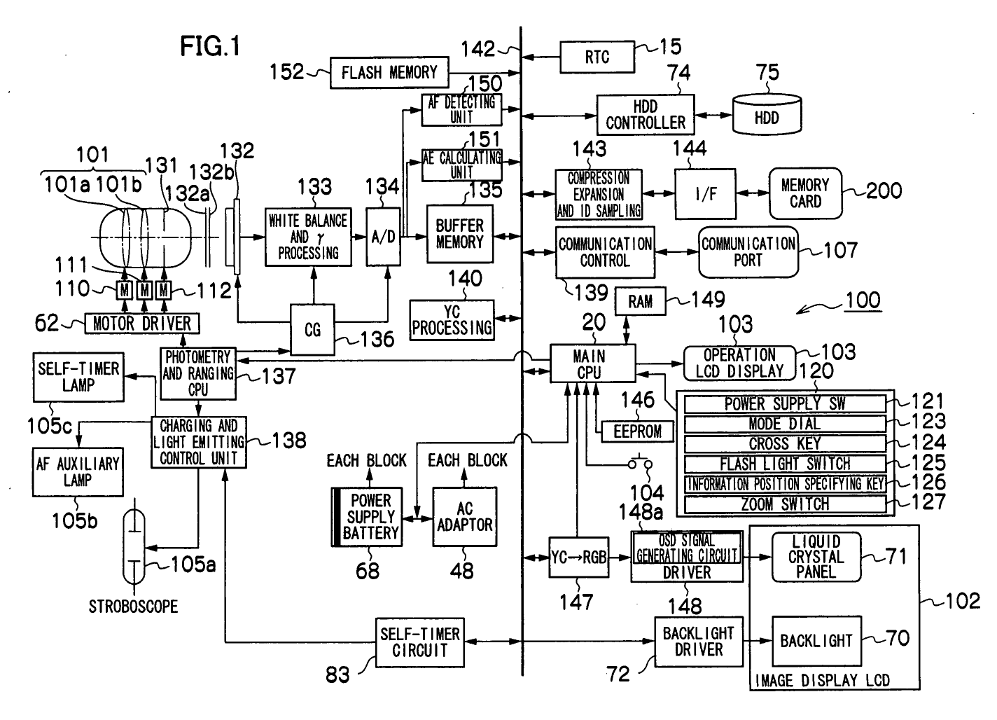

FIG. 1 is a block diagram of a camera 100. The camera 100 includes an operating unit 120 by which a user performs various operations to use the camera 100. The operating unit 120 includes a power supply switch 121 for turning on a power supply to operate the camera 100, a mode dial 123 for selecting automatic imaging or manual imaging, etc., a cross key 124 for setting or selecting various menus or zooming, a flash light switch 125 and an information position specifying key 126 for executing or canceling etc., the menus selected by the cross key 124.

The camera 100 further includes an image display LCD 102 for displaying a picked up image and a reproduced image and an operation LCD display 103 for aiding operations.

The camera 100 is equipped with a release switch 104. The release switch 104 transmits an instruction for starting an image pickup to a main CPU 20. Modes can be switched at discretion between an imaging mode and a reproducing mode by a predetermined menu screen in the camera 100. In addition, the camera 100 is provided with an AF auxiliary lamp 105b including a light emitting diode (LED) for illuminating a projecting spot on an object at the time of a contrast AF and a flashlight emitting device with a stroboscope 105a emitting a flashlight.

The camera 100 further includes an imaging lens 101, a diaphragm 131, and a CCD sensor 132 (hereinafter, referred to as CCD 132) being an imaging device for converting an object image imaged through the imaging lens 101 and the diaphragm 131 into an analog image signal. The CCD 132 stores electric charges generated by the object light illuminated on the CCD 132 for a variable electric-charge storing time period (or, an exposure period) to generate an image signal. The CCD 132 sequentially outputs the image signal on a frame basis at the timing synchronized with a vertical synchronizing signal VD output from a CG unit 136.

When the CCD 132 is used as an imaging device, an optical lowpass filter 132a is disposed for removing unwanted high frequency components in the incident light to prevent a color aliasing and a moire fringe pattern from being generated. In addition, an infrared cut filter 132b is disposed which absorbs and reflects infrared rays in the incident light to compensate sensitivity characteristics unique to the CCD sensor 132 of which sensitivity is high in a long wavelength range. How to concretely dispose the optical lowpass filter 132a and the infrared cut filter 132b is not particularly limited.

Furthermore, the camera 100 is provided with a white balance and γ processing unit 133 which matches the white balance of the object image represented by the analog image signal from the CCD sensor 132, adjusts the inclination (γ) of a straight line in the gradation characteristics of the object image and includes an amplifier with a variable amplification factor which amplifies the analog image signal.

Still furthermore, the camera 100 includes an A/D converting unit 134 which converts the analog signal from the white balance and γ processing unit 133 into digital RGB image data and a buffer memory 135 which stores the RGB image data from the A/D converting unit 134.

The AF detecting unit 150 calculates integrated average of the RGB image data for each of predetermined divided areas of one screen and for each of color components. Further, the AF detecting unit 150 calculated integrated averages Ir, Ig and Ib of the RGB image data of entire area for each frames. The Ir, Ig and Ib are taken to be the amounts of received visible light of R, G and B.

The amount Ir, Ig and Ib of received visible light of R, G, and B may be detected by a photo sensor (not shown) sensitive to the R, G and B visible light instead of the CCD 132.

Still furthermore, the camera 100 includes a clock generator (CG) unit 136, a photometry and ranging CPU 137, a charging and light emitting control unit 138, a communication control unit 139, a YC processing unit 140 and a power supply battery 68.

The CG unit 136 outputs the vertical synchronizing signal VD for driving the CCD sensor 132, a driving signal including a high-speed sweeping pulse P, a control signal for controlling the white balance and γ processing unit 133 and the A/D converting unit 134, and a control signal for controlling the communication control unit 139. In addition, a control signal is input from the photometry and ranging CPU 137 into the CG unit 136.

The photometry and ranging CPU 137 controls a zoom motor 110, a focus motor 111 and a diaphragm motor 112 for adjusting the diaphragm and drives a zoom lens 101a, a focus lens 101b and the diaphragm 131 respectively, thereby calculating a distance to an object (ranging) to control the CG unit 136 and the charging and light emitting control unit 138. The drive of the zoom motor 110, the focus motor 111 and the diaphragm motor 112 is controlled by a motor driver 62. The control command for the motor driver 62 is sent from the photometry and ranging CPU 137 or the main CPU 20.

The driving sources for the zoom lens 101a, the focus lens 101b, the diaphragm 131 and AF auxiliary light illumination angle do not always need to be limited to such motors as the zoom motor 110, the focus motor 111 and the diaphragm motor 112, but an actuator, etc. may be used as a driving source.

Half depressing the release switch 104 (S1 ON) causes the photometry and ranging CPU 137 to measure the brightness of an object (calculation of EV value) based on image data (or a live-view image) periodically (every 1/30 sec to 1/60 sec) obtained by the CCD 132.

That is to say, an AE calculating unit 151 integrates the R, G and B image signals output from the A/D converting unit 134 and provides the integrated value for the photometry and ranging CPU 137. The photometry and ranging CPU 137 detects an average brightness of the object (object luminance) based on the integrated value input from the AE calculating unit 151 to calculate an exposure (EV value) suitable for imaging.

The photometry and ranging CPU 137 determines a diaphragm value (F value) and an exposure including the electronic shutter (shutter speed) of the CCD 132 based on the obtained EV value and according to a predetermined program diagram (AE operation).

Completely depressing (S2 ON) the release switch 104 causes the photometry and ranging CPU 137 to drive the diaphragm 131 based on the determined diaphragm value to control the aperture of the diaphragm 131 and to control an electric charge storing time in the CCD 132 through the CG 136 based on the determined shutter speed.

The AE operations include a diaphragm priority AE, a shutter speed priority AE and a program AE. In either case, the AE operation is controlled to pick up an image at an appropriate exposure such that an image is picked up at the exposure determined based on the measured object luminance, i.e., at a combination of a diaphragm value and a shutter speed. This enables eliminating a complicated process for determining an exposure.

The AF detecting unit 150 samples image data corresponding to a detection range selected by the photometry and ranging CPU 137 from the A/D converting unit 134. A focal position is detected by taking advantage of a characteristic that the amplitude of high frequency components of image data is maximized at a focusing position. The AF detecting unit 150 calculates an amplitude value by integrating the high frequency components of the sampled image data over one field period. The AF detecting unit 150 sequentially calculates amplitude values while the photometry and ranging CPU 137 drives and controls the focus motor 111 to move the focus lens 101b in the movable range, i.e., in the end point on the infinity side (INF point) to the end point on the very near side (NEAR point) and transmits a detected value to the photometry and ranging CPU 137 when it detects the maximum amplitude.

The photometry and ranging CPU 137 receives the detected value and issues a command to the focus motor 111 to move the focus lens 101b to the corresponding focusing position. The focus motor 111 moves the focus lens 101b to the focusing position in accordance with the command from the photometry and ranging CPU 137 (AF operation).

The photometry and ranging CPU 137 is coupled to the release switch 104 through inter-CPU communication with the main CPU 20. When a user half depresses the release switch 104, the focusing position is detected. In addition, the photometry and ranging CPU 137 is coupled to the zoom motor 110. When the main CPU 20 receives a command to zoom to a TELE or a WIDE direction from the user through the zoom switch 127, the zoom motor 110 is driven to move the zoom lens 101a between the WIDE end (wide angle end) and the TELE end (telephoto end).

The charging and light emitting control unit 138 is supplied with an electric power from the power supply battery 68 to charge a capacitor (not shown) for emitting a flashlight to emit the stroboscope 105a and controls the emission of the stroboscope 105a.

The charging and light emitting control unit 138 starts charging the power supply battery 68 and controls the supply of electric current to a self-timer lamp (tally lamp) 105c and an AF auxiliary lamp 105b in response to the capture of various signals such as half- and complete-depressing signals of the release switch 104 and signals representing the amount of light emission and light emitting timing from the main CPU 20 and the photometry and ranging CPU 137 to obtain a desired amount of light emission at a desired timing.

Incidentally, the self-timer lamp 105c may be formed of an LED or common to the LED forming the AF auxiliary lamp 105b.

A self-timer circuit 83 is connected to the main CPU 20. When a self-imaging mode is set, the main CPU 20 clocks time based on the complete depressing signal of the release switch 104. The main CPU 20 causes the self-timer lamp 105c to blink through the photometry and ranging CPU 137 at the time of clocking time while gradually increasing a blinking speed matching with a remaining time. The self-timer circuit 83 inputs a clocking-time completion signal to the main CPU 20 after clocking has been completed. The main CPU 20 causes the CCD 132 to perform a shutter operation based on the clocking-time completion signal.

The communication control unit 139 is equipped with a communication port 107 and outputs the image signal of an object captured by the camera 100 to an external apparatus such as a personal computer with a USB terminal and inputs an image signal from the external apparatus to the camera 100 to perform data communication with the external apparatus. The camera 100 has a sensitivity changing function simulating a function, switching to ISO sensitivity 64, 100, 200, 400, 800 and 1600, etc., of an ordinary camera in which an image is focused on to a rolled photographic film. When the ISO sensitivity is switched to 400 or higher, the camera will be in a high sensitivity mode set to a high amplification factor at which the amplification factor of the amplifier in the white balance and γ processing unit 133 exceeds a predetermined amplification factor. The communication control unit 139 stops communication with the external apparatus while picking up an image in the high sensitivity mode.

The camera 100 further includes a compression expansion and ID sampling unit 143 and an I/F unit 144. The compression expansion and ID sampling unit 143 reads out the image data stored in the buffer memory 135 through bus line 142, compresses the image data and stores it in the memory card 200 through the I/F unit 144. When the compression expansion and ID sampling unit 143 reads out the image data stored in the memory card 200, the compression expansion and ID sampling unit 143 extracts an identification number (ID) unique to the memory card 200, reads out the image data stored in the memory card 200, expands the image data and stores it in the buffer memory 135.

A Y/C signal stored in the buffer memory 135 is compressed by the compression expansion and ID sampling unit 143 according to a predetermined format and then recorded in a removable media like the memory card 200 through the I/F 144 or in a built-in large capacity recording medium like a hard disk (HDD) 75 according to a predetermined format, for example, an exchangeable image file format (Exif) file. A hard disk controller 74 controls recording data in the hard disk (HDD) 75 and reading out data from the hard disk (HDD) 75 in accordance with the command from the main CPU 20.

In addition, the camera 100 includes the main CPU 20, an EEPROM 146, a YC/RGB converting unit 147 and a display driver 148. The main CPU 20 controls the entire camera 100. The EEPROM 146 stores solid data and programs unique to the camera 100. The YC/RGB converting unit 147 converts a color video signal YC generated by a YC processing unit 140 into RGB signals and outputs them to the image display LCD 102 through the displaying driver 148.

An AC adaptor 48 for receiving an electric power from an AC power supply and the power supply battery 68 can be detached from the camera 100. The power supply battery 68 is formed of a rechargeable secondary battery such as, for example, a Nickel-Cadmium battery, a nickel metal hydride battery and a lithium-ion battery. The power supply battery 68 may be formed of a disposal primary battery, for example, a lithium cell and an alkaline battery. The power supply battery 68 is inserted into a battery compartment (not shown) to be electrically connected to each circuit of the camera 100.

When the AC adaptor 48 is fitted into the camera 100 to supply an electric power from the AC power supply to the camera 100 through the AV adaptor 48, even if the power supply battery 68 is inserted into the battery compartment, the electric power output from the AV adaptor 48 is preferentially supplied to each portion of the camera 100 as a driving electric power. When the AC adaptor 48 is not fitted but the power supply battery 68 is inserted into the battery compartment, the electric power output from the power supply battery 68 is supplied to each portion of the camera 100 as a driving electric power.

The camera 100 includes a backup battery (not shown) in addition to the power supply battery 68 housed in the battery compartment. For example, a dedicated secondary battery is used as the built-in backup battery and charged by the power supply battery 68. The backup battery supplies an electric power to the basic functions of the camera 100 when the power supply battery 68 is not inserted into the battery compartment, for example, when the power supply battery 68 is replaced or removed.

That is to say, when the power supply battery 68 or the AC adaptor 48 stops supplying an electric power, a switching circuit (not shown) connects the backup battery to the RTC 15 to supply these circuits with an electric power. Thus, the electric power is continuously supplied to the basic functions of the camera 100 such as the RTC 15 unless the backup battery 29 reaches its lifetime.

The real time clock (RTC) 15 is a chip dedicated to clocking time and is continuously operated by the backup battery even if the power supply battery 68 or the AC adaptor 48 stops supplying power thereto.

The image display LCD 102 is provided with a backlight 70 for illuminating a transparent or a translucent liquid crystal panel 71 from the back thereof. In a power saving mode, the brightness (luminance) of the backlight 70 is controlled through a backlight driver 72 to reduce the consumption power of the backlight 70. The power saving mode can be set to ON/OFF such that the information position specifying key 126 on the operating unit 120 is depressed to display the menu screen on the image display LCD 102 and a predetermined manual input is performed on the menu screen.

The camera 100 has an automatic power-off setting function to save an electric power as is the case with cameras appeared on the market in recent years. When the automatic power-off setting is effective, a continuous time period in a standby state over which nothing is input into the operating unit 120 is clocked by the RTC 15. When a predetermined time period, for example, 3 minutes in a standby state passes, the camera 100 causes the power supply battery 68 and others to stop supplying an electric power to the backlight 70 or each block of the camera 100 main body. The automatic power-off setting can be validated or released at discretion by a predetermined input into the operating unit 120.

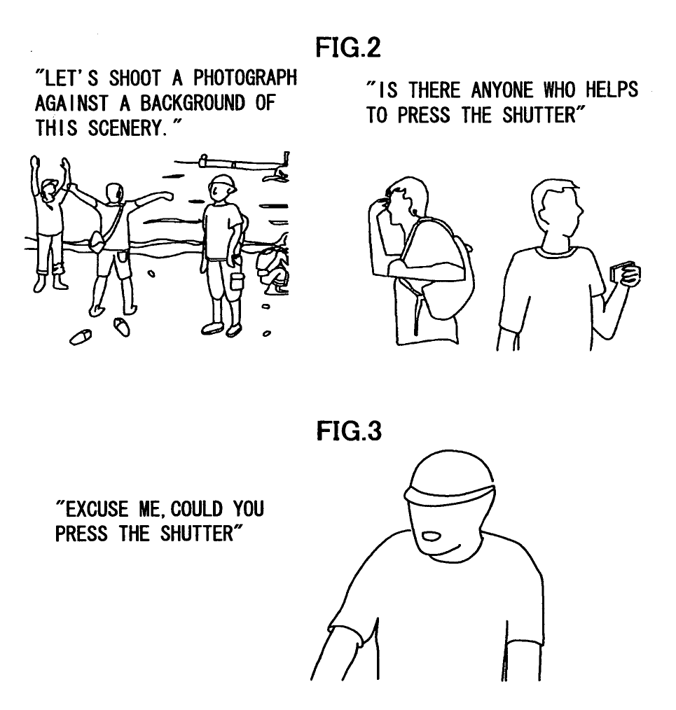

The flow of picking up an image and the operation of the camera 100 are described with reference to FIGS. 2 to 11.

As illustrated in FIG. 2, a user of the camera 100 looks for someone there and asks him or her to take its group photo, as illustrated in FIG. 3.

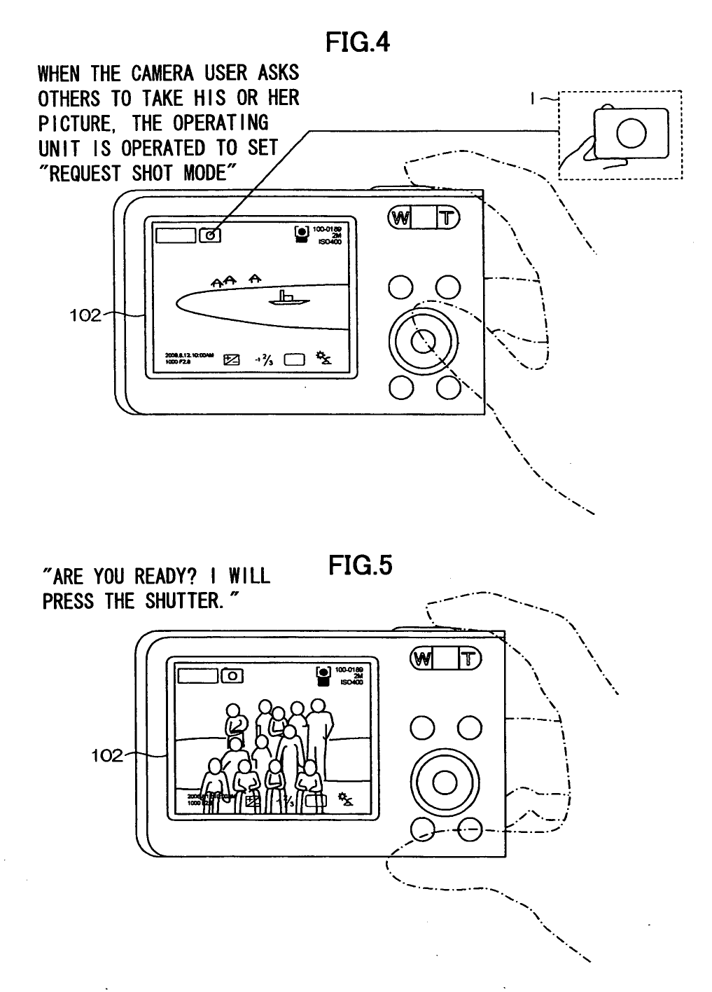

When the user asks someone to shoot a photograph, the operating unit 120 is operated to set “Request shot mode” as illustrated in FIG. 4.

How to set “Request shot mode” depends on user's discretion. For example, following the setting of an imaging mode, the item of “Request shot mode” is selected from the menu to set “Request shot mode.” A button dedicated to “Request shot mode” may be provided on the operating unit 120 to repeat the setting and the release of “Request shot mode” in response to the depression of the dedicated button. Alternatively, the item of “Request shot mode” may be incorporated into other modes as to imaging such as, for example, a part of items for self-timer setting. The setting item of “Request shot mode” may be added to the menu following the setting item of residual time of the self-timer “2 seconds,” “10 seconds” and others, thereby enabling selecting and setting “Request shot mode” in the same column as the residual time of the self-timer in one menu.

As illustrated in FIG. 4, the CPU 20 causes the LCD 102 to starts displaying the live-view image when the “Request shot mode” is set. As illustrated in FIG. 11, a display region R1 on the LCD 102 (the liquid crystal panel 71) displaying the live-view image is set smaller than an entire region R0 including an actually captured image data by decreasing a finder field rate by decrements of 20% in aspect ratio. Though described in detail later, this allows for a margin of an acquired image region which disappears from the live-view image in consideration that the shooter is unfamiliar with setting an appropriate composition.

The CPU 20 causes an OSD signal generating circuit 148a to generate an image of an icon I showing that the “Request shot mode” is set in response to the setting of “Request shot mode” and synthesizes the icon with the live-view image.

Furthermore, the CPU 20 may perform at least one of the following: setting the number of pixels in which image data is recorded in the memory card 200 to the maximum number of pixels (maximum pixel size, for example, 2M pixels); setting the high sensitivity mode, setting an automatic exposure adjustment mode and an automatic focus adjustment mode (face detection AEIAF) according to face recognition; releasing the automatic power-off of the backlight 70; releasing the automatic power-off of the camera 100 main body; setting a quick shot mode (in which a recording image is captured in response to the complete depression of the release switch 104 at one stroke without the half depression thereof); setting a continuous shooting mode (for example, continuous two frames with and without flash of the strobe 105a and shooting three frames without flash of the strobe 105a); stopping the syntheses of other images except the icon I with the live-view image; or nullifying inputs into the operating unit 120 until the release switch 104 is completely depressed.

This increases the probability that a good picture-quality image is obtained and decreases the probability that a failed image is obtained. In addition, the display of the icon on the LCD 102 is simplified, so that one who asked to shoot a photograph (or one who shoots a photograph) can concentrate on the live-view image without being confused by the display of the icon. Furthermore, since the backlight 70 of the LCD 102 is kept lighted, the extinguishment of the backlight 70 does not prevent composition from being confirmed through the live-view image. This also avoids such an inconvenience that buttons except the release switch are inadvertently operated to release the imaging mode. This also provides an image in which focus and exposure to a face are automatically adjusted. Even if the shooter completely depresses the release switch at one stroke without knowing the operation of half depression, imaging is completed. The high sensitivity mode prevents failure due to a camera shake.

The release of setting of the automatic power-off in the camera 100 main body does not hinder shooting caused by the operation of the automatic power-off during shooting.

Although the release of setting of the automatic power-off in the camera 100 main body may be maintained while the “Request shot mode” is being set, the setting of the automatic power-off is preferably released only for a predetermined period during which one who asked to shoot a photograph finishes shooting of the photograph.

The predetermined period until one who asked to shoot a photograph finishes shooting is set longer than the standby time in an ordinary automatic power-off setting, for example, to be five minutes if the standby time during which the power of the camera 100 main body is automatically turned off is set to be three minutes. Thus, setting longer a standby time of the automatic power-off further decreases hindering shooting caused by the operation of the automatic power-off during shooting.

As illustrated in FIG. 5, the shooter determines a composition while referring to the live-view image and completely depresses the release switch 104. The main CPU 20 controls the shutter operation of the CCD 132 in response to the complete depression of the release switch 104 (or half-depression) and acquires image data for recording.

When the quick shot mode is set, the CPU 20 momentarily executes the AE and the AF operation in response to the complete depression (or half-depression) of the release switch 104 (full automatic mode), controls the focus motor 111 based on the calculated result to momentarily move the focus lens 101b to the focal position and controls the diaphragm motor 112 to momentarily drive the diaphragm 131. When the face detection AE/AF is set, the CPU 20 calculates an AF evaluation value based on the image data in a face region detection range in the live-view image and takes a lens position corresponding to the peak of the AF evaluation value as a focal position. For this reason, the whole area search is not performed. The face region detection range is detected is limited to a detected face region or its vicinity. The range where the EV value is calculated by the AE calculating unit 151 is also limited to the detected face region or its vicinity. This prevents the shooter from focusing on a background and shooting against the light.

The acquired image data for recording is recorded in the memory card 200 in a predetermined format.

The CPU 20 transmits a post-view image which is obtained by developing the image data recorded in the memory card 200 into the buffer memory 135 to the YC processing unit 140 through the bus line 142. The YC/RGB converting unit 147 converts a color video signal YC corresponding to the post-view image, which is generated by the YC processing unit 140 into RGB signals and outputs them to the image display LCD 102 through the displaying driver 148.

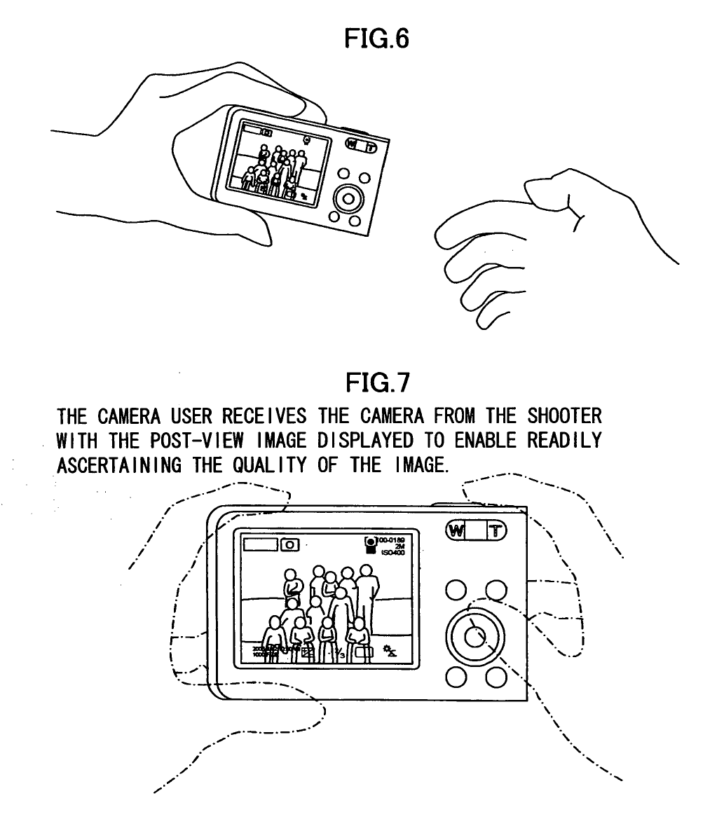

As a result, as illustrated in FIG. 6, the post-view image is displayed on the LCD 102. As illustrated in FIG. 7, one who asks someone to shoot a photograph receives the camera from the shooter with the post-view image displayed to enable him/her to readily ascertain the quality of the image.

The range where the post-view image is displayed is set to a predetermined limited region R2 smaller than the actual whole area of recorded image. It is needless to say that the limited region R2 may be equal to the display range for the live-view image (R2=R1). The limit of the display range in the limited region R2 is released according to the setting of the reproducing mode.

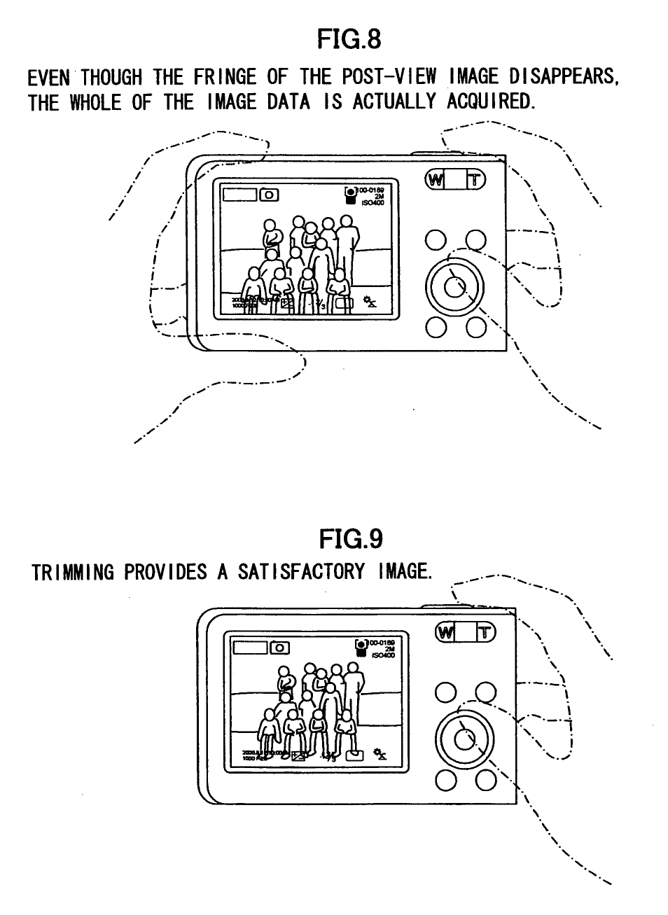

As illustrated in FIG. 8, even if the fringe of the post-view image disappears at a glance due to a small angle of view, the whole of the actually acquired image data displayed according to the setting of the reproducing mode is larger than the post-view image, as illustrated in FIG. 9. Therefore, even if the composition looks bad in the post-view image, the image actually recorded and displayed in the reproducing mode includes a peripheral region outside of the post-view image. The possible cutoff of heads and legs from the image at the upper and the lower part of the screen can be compensated, so that there is no need for shooting again.

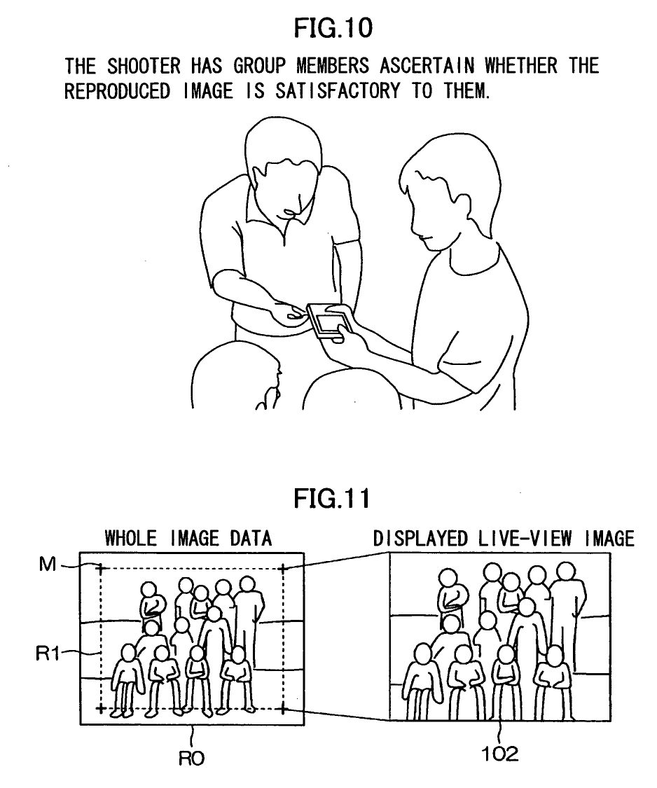

As illustrated in FIG. 10, the shooter has group members ascertain whether the reproduced image is satisfactory to them. If the image is satisfactory, the image can be kept as it is. Alternatively, an unwanted peripheral region may be trimmed to obtain a satisfactory image. If the image is recorded at the maximum number of pixels, the image is less degraded even if the image is zoomed to a desired size after trimming. If it is inevitable to shoot again, the “Request shot mode” can be set again and pass the camera 100 to someone who shoots a photograph.

Incidentally, as suggested by a conventional art (for example, Japanese Patent Application Laid-Open No. 2001-128112), it is generally preferable that imaged angle of view coincides with angle of view of the display output, however, in the present embodiment, imaged angle of view is intentionally differentiated from the angle of view of the displaying output to compensate the cutoff of the image. Care should be exercised in that the point to which the present embodiment directs its attention is radically different from the approach of the conventional art.

As illustrated in FIG. 11, a maker M showing a range displaying the post-view image may be recorded in the image data in itself or the tag portion of the Exif image file as a target for trimming the image.

As illustrated in FIG. 11, the markers M are provided on the four corners of the recorded image at the time of reproducing the recorded image to show the position and the range of the post-view image at the time of shooting. Alternatively, a rectangular marking may be displayed to show the position of the post-view image at the time of shooting. Alternatively, the post-view image at the time of shooting (an image whose angle of view is reduced) may be displayed by setting the “Request shot mode” by depressing the operating unit 120 when the recorded image is displayed on the LCD 102.

Thus, anybody can lightly ask someone to take a satisfactory picture using the “Request shot mode” in the camera 100 according to the embodiments of the present invention. One who asked to shoot a photograph merely depresses the release switch to obtain a satisfactory picture and can readily receive a request for shooting.

What is claimed is:

1. An imaging apparatus including an imaging unit which receives light incident from an object through an imaging lens, continuously converts it into an image signal and outputs the image signal, an image data conversion unit which converts the image signal output from the imaging unit into an image data and outputs the image data, a recording instruction unit which receives a recording instruction of the image data, an exposure controlling unit which controls the exposure of the imaging unit in response to the recording instruction unit receiving the recording instruction, a recording unit which records the image data converted from the image signal output from the imaging unit in response to control of exposure by the exposure controlling unit and a display unit which displays the image data recorded at least in the recording unit, the imaging apparatus comprising:
a shooting requesting unit which receives an input indicating that shooting request to a person is made; and
a shooting request mode setting unit which sets an angle of view of the image data displayed by the display unit to a predetermined range smaller than an angle of view captured by the imaging unit in response to the input indicating that shooting request to a person is made inputted to the shooting requesting unit; wherein
the display unit displays a post-view image which is an image data decoded from compressed coded image data in the recording unit within a range of the displayed angle of view set by the shooting request mode setting unit.

2. The imaging apparatus according to claim 1, wherein
the display unit continuously displays the post-view image until a reproducing mode for the image data is set after the recoding unit has compressed and coded the image data and recorded it.

3. The imaging apparatus according to claim 1, wherein
the recoding unit associates information identifying the displayed angle of view set by the shooting request mode setting unit with the image data and records the information.

4. The imaging apparatus according to claim 1, wherein
the shooting request mode setting unit, in response to the input indicating that shooting request to a person is made inputted to the shooting requesting unit, performs at least one of the following: setting the number of pixels in which image data is recorded to the maximum number of pixels; setting the high sensitivity mode; setting an automatic exposure adjustment mode and an automatic focus adjustment mode according to face recognition; releasing the automatic power-off of the backlight in the display unit; releasing the automatic power-off of the imaging apparatus main body; setting a quick shot mode; setting a continuous shooting mode; stopping the display of an icon in a live-view image or limitation thereof; and nullifying the operation of other buttons except a shutter button until the shutter button is completely depressed.

5. The imaging apparatus according to claim 4, wherein
the recoding unit associates information identifying the displayed angle of view set by the shooting request mode setting unit with the image data and records the information.

6. The imaging apparatus according to claim 4, wherein
the display unit continuously displays the post-view image until a reproducing mode for the image data is set after the recoding unit has compressed and coded the image data and recorded it.

7. The imaging apparatus according to claim 6, wherein
the recoding unit associates information identifying the displayed angle of view set by the shooting request mode setting unit with the image data and records the information.

8. A method of controlling shooting comprising the steps of:
receiving an input indicating that shooting request to a person is made;
setting a displayed angle of view of an image data to a predetermined range smaller than a shooting angle of view in response to the input indicating that shooting request to a person is made; and
displaying a shot image data within the range of the set displayed angle of view.
